(19) United States
(12) Patent Application Publication
(10) Pub. No.: US 2008/0279343 A1
(43) Pub. Date: Nov. 13, 2008

(54) TELEPHONE WITH EMERGENCY LIGHTING FEATURE

(76) Inventors: Jon Bentley, New Providence, NJ (US); Anjur Sundaresan Krishnakumar, Rocky Hill, NJ (US); David M. Weiss, Long Valley, NJ (US)

Correspondence Address: MG-IP Law, PLLC, PO BOX 1364, FAIRFAX, VA, 22038-1364, US

(21) Appl. No.: 11/747,881

(22) Filed: May 11, 2007

(51) Int. Cl. H04M 3/08; H04M 3/22

(52) U.S. Cl. 379/33

(57) ABSTRACT

A telephone of the corded or portable type includes a light source. The light source may or may not have an ability to be pivoted or swiveled to illuminate a desired portion of a room. In the case of a corded telephone, the light source may be detachable from the telephone. The light source may be automatically activated to provide emergency illumination when a power failure condition exists in a building. The light source may also be manually activated to provide a convenient illumination source for the user.

### BACKGROUND OF THE INVENTION

1. Field of the Invention

The present invention relates to telephones, of the corded and cordless types. More particularly, the present invention relates to a corded desktop telephone or a cordless telephone which includes a light source that can be manually or automatically activated to provide illumination during an emergency situation.

2. Description of the Related Art

In large buildings, such as offices, schools, churches, hotels and the like, emergency backup lighting systems are often employed. In case of a power failure, the backup lights are turned on to illuminate key points inside the building. The backup lights typically illuminate main hallways and stairways.

The backup lights typically have internal batteries which are constantly trickle charged from the main power supply of the building. When the main power supply is interrupted, a sensor, inside of the backup light, senses the interruption and turns on the backup light to provide illumination via the stored power within the internal battery. Another known technique is to hardwire the backup lights to a central backup power generator. When a power failure is sensed, the central backup power generator is automatically started and power is then transmitted to the hardwired backup lights to illuminate the key escape areas within the building.

### SUMMARY OF THE INVENTION

The Applicants have appreciated one or more drawbacks associated with the designs of the prior art. First, the backup lights of the prior art are expensive to manufacture, install and maintain.

Second, Applicants have appreciated that backup lighting is typically only available in key escape areas such as main hallways and stairways. This is due in part to the expense of each backup light. Typically, there are no backup lights in individual personal offices, conference rooms, kitchens, file rooms, and other similar types of rooms. Such rooms are often interior rooms without windows, such that when a power failure occurs, the occupants of these rooms are stranded in absolute darkness. Even exterior rooms with windows can become very dark during a power failure due to window tinting and shades, as well as when a power failure occurs at night. Injuries can result from individuals tripping over obstacles in the floor when attempting to locate the door to exit the room, so as to reach a hallway.

It is an object of the present invention to address one or more of the drawbacks of the prior art backup lighting systems and/or Applicant's appreciated needs in the art.

The Applicants have appreciated that nearly every room in a building includes a telephone. Personal offices and conference rooms have telephones without fail, and kitchens and file rooms also commonly have telephones. The Applicants have appreciated that providing a light source on the telephone, providing even a minimal level of illumination, will greatly supplement the backup lighting system of a building by providing illumination in areas previously un-serviced by the backup lighting system.

According to one embodiment, the present invention includes a telephone of the corded or portable type including a light source. The light source may or may not have an ability to be pivoted or swiveled to illuminate a desired portion of a room. In the case of a corded telephone, the light source may be detachable from the telephone. The light source may be automatically activated to provide emergency illumination when a power failure condition exists in a building. The light source may also be manually activated to provide a convenient illumination source for the user.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view a corded telephone, in accordance with the present invention;

FIG. 2 is a perspective view of a light source, in accordance with the present invention;

FIG. 3 is a top side view of a corded telephone having alternative coupling features;

FIG. 4 is a perspective view of a light source having alternative coupling features;

FIG. 5 is a top view of the light source attached to the corded telephone;

FIG. 5A is a top view of a corded telephone with an integrated light source, in accordance with an alternative embodiment of the present invention;

FIG. 6 is a block diagram representing one embodiment for circuitry within the light source;

FIG. 7 is a front view of a cordless telephone including an illumination device, in accordance with the present invention;

FIG. 8 is a side view of the cordless telephone of FIG. 6 resting on a base station;

FIG. 9 is a diagram illustrating an emergency illumination system in combination with a power-over-Ethernet telephony system; and

FIG. 10 is an illustration of a power sensing module for use in the network of FIG. 9.

### DETAILED DESCRIPTION OF A PREFERRED EMBODIMENT

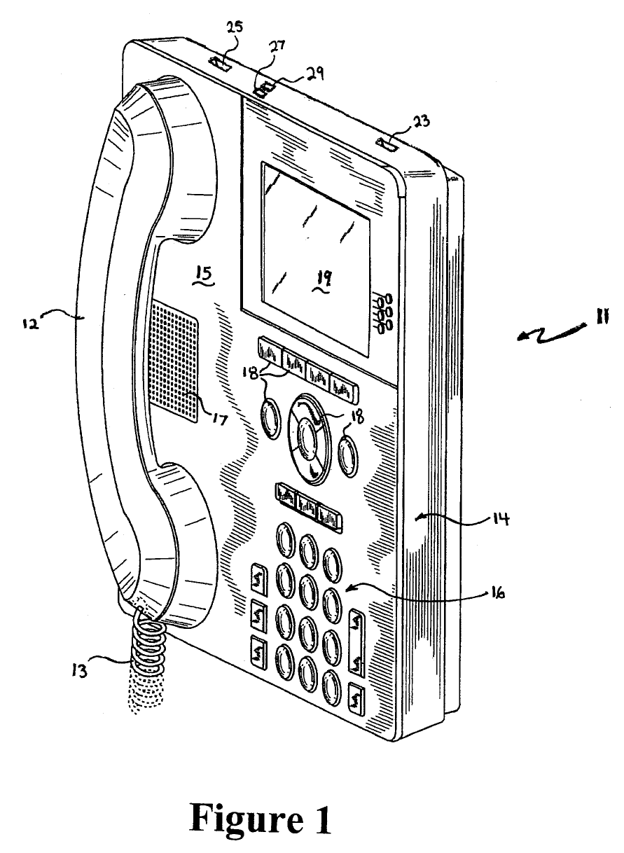

FIG. 1 illustrates a corded telephone 11, in accordance with the present invention. The corded telephone 11 includes typical telephone structures, such as a handset 12 attached to a base 14 by a cord 13. The base 14 includes a housing 15 presenting a numerical keypad 16, a speaker 17, a plurality of function keys 18 and a display 19.

FIG. 1 illustrates first coupling features along a top edge of the corded telephone 11. The first coupling features include a first open slot 23, a second open slot 25, a first electrical pad 27, and a second electrical pad 29. Although FIG. 1 illustrates the first coupling features as being disposed along a top edge of the corded telephone 11, the coupling features could be located along any surface of the corded telephone 11, such as the bottom edge, a side edge or even the top side of the telephone. Also, the structure and/or relative placements of the first coupling features may be altered, as will be discussed hereinafter in conjunction with figures to follow.

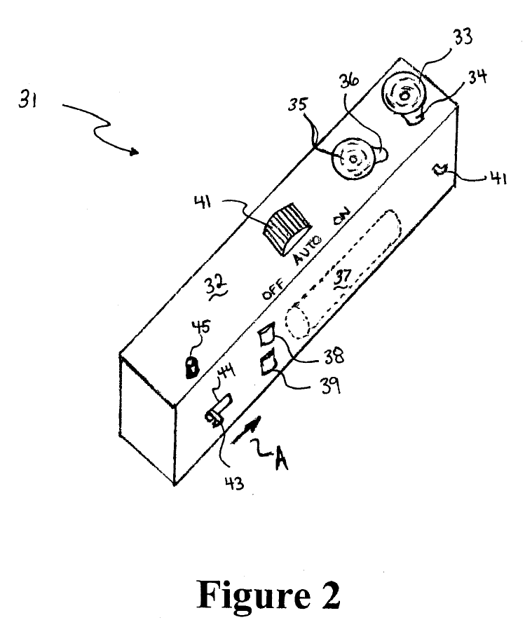

FIG. 2 illustrates a handheld light source 31. The light source 31 includes a first light emitting element 33 and a second light emitting element 35. The first light emitting element 33 is held by a base 34 which is pivotably and rotatably secured to a housing 32 of the light source 31, such that the first light emitting element 33 may swivel relative to the housing 32 to a position desired by the user, and remain in the desired position via a frictional resistance. Likewise, the second light emitting element 35 is held by a base 36 which is pivotably and rotatably secured to the housing 32, such that the second light emitting element 35 may swivel relative to the housing 32 to a position desired by the user, and remain in the desired position via a frictional resistance.

A rechargeable power source 37, such as an AA NiMH battery, is housed within light source 31. The rechargeable power source 37 can selectively power the first and second light emitting elements 33 and 35. A third electrical pad 38 and a fourth electrical pad 39 are exposed on the side of the housing 32. The third and fourth electrical pads 38 and 39 are provided to receive power for charging the rechargeable power source 37. A user switch 41 is provided on the surface of the housing 32. The user switch 41 includes three positions, “off,” “auto” and “on,” as will be more fully described hereinafter.

The light source 31 includes second coupling features. The second coupling features include a first hook 41 rigidly attached to the side of the housing 32 and a second hook 43 moveably attached to the side of the housing 32. A release button 45 is also provided on the exterior of the housing 32. Pressing the release button 45 causes the second hook 43 to slide within a channel 44 in the direction of arrow A against a spring biasing force.

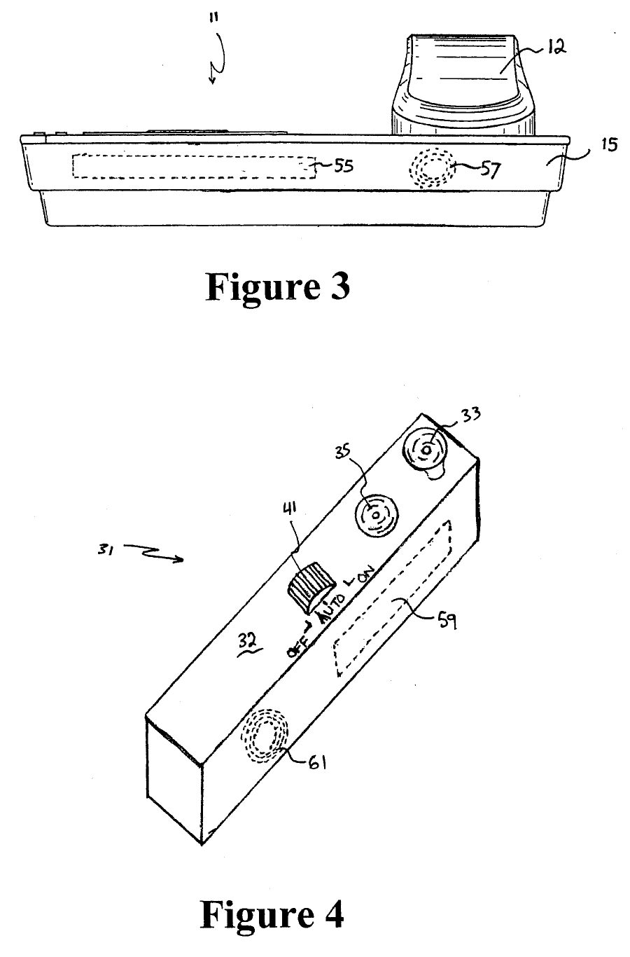

FIG. 3 depicts alternative first coupling features for the corded telephone 11. The first and second open slots 23 and 25 have been replaced by a first magnet 55 placed within the housing 15 behind the plastic material of the top edge. Alternatively, the first magnet 55 may be embedded within the plastic material used to form the top edge of the housing 15. The first and second electrical pads 27 and 29 have been replaced by a first inductive loop 57.

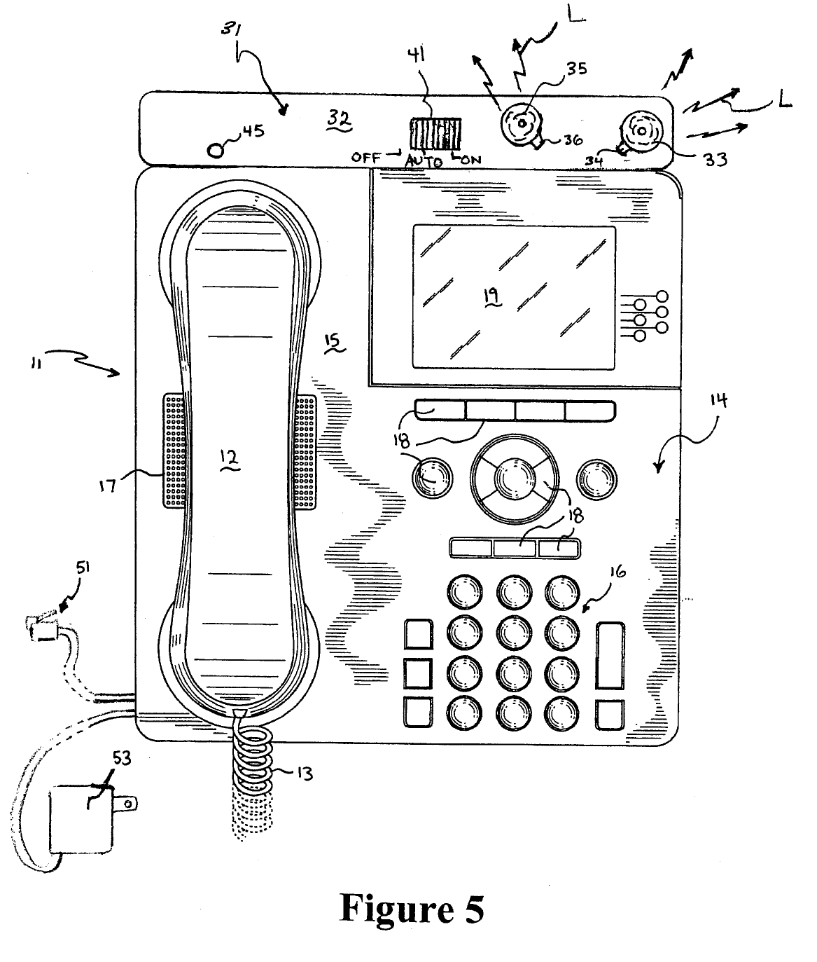

FIG. 4 depicts alternative second coupling features for the light source 31. The first and second hooks 41 and 43, and the channel 44 and release button 45 have been replaced by a second magnet 59 placed within the housing 32 behind the plastic material. Alternatively, the second magnet 59 may be embedded within the plastic material used to form the housing 32. The third and fourth electrical pads 38 and 39 have been replaced by a second inductive loop 61.

FIGS. 2 and 4 are only graphical representations of utilitarian aspects of the light source 31. Of course, the edges may be rounded and the general contours of the light source 31 may be modified to provide for a much more ergonomically appealing and attractive light source 31.

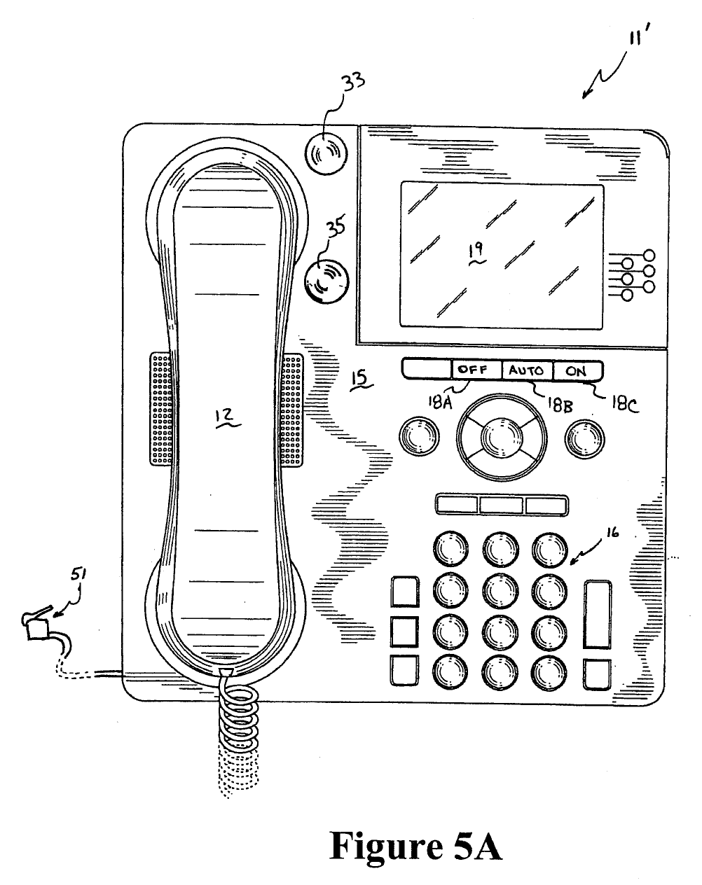

FIG. 5 illustrates the attached of the light source 31 (FIGS. 2 or 4) and the housing 15 of the corded telephone 11 (FIGS. 1 or 3). In the case of FIGS. 1 and 2, to attach the light source 31 to the corded telephone 11, the first hook 41 is inserted into the first open slot 23. Next, the second hook 43 is manually pressed against an outer edge of the second open slot 25, which causes the second hook 43 to overcome the spring biasing force and move in the channel 44 in the direction of arrow A. Once the second hook 43 clears the outer edge of the second open slot 25, the spring biasing force causes the second hook 43 to move in the direction opposite arrow A and to “snap lock” the light source 31 to the corded telephone 11.

When the light source 31 is attached to the corded telephone 11, the third electrical pad 38 is in electrical contact with the first electrical pad 27, and the fourth electrical pad 39 is in electrical contact with the second electrical pad 29. These electrical connections make it possible for the rechargeable power source 37 to be recharged by power exiting the corded telephone 11 via the first and second electrical pads 27 and 29, when said light source 31 is attached to the corded telephone 11.

To remove the light source 31 from the corded telephone 11, the user manually depresses the release button 45, which causes the second hook 43 to move against the spring biasing force in the channel 44 in the direction of arrow A. Once the second hook 43 clears the edge of the second open slot 25, the user may withdraw the second hook 43 from the second open slot 25. Next, the light source may be slid slightly to the left in FIGS. 1 and 3 to remove the first hook 41 from the first open slot 23. Then, the light source is completely freed from the corded telephone 11.

In the case of FIGS. 3 and 4, to attach the light source 31 to the corded telephone 11, one merely needs to bring the second magnet 59 of the light source 31 into close proximity with the first magnet 55 of the corded telephone 11. The first and second magnets 55 and 59 will mutually attract each other causing the light source 31 to attach itself to the top edge of the corded telephone 11 at a precise position.

When the light source 31 is attached to the corded telephone 11, the first inductive loop 57 of the corded telephone 11 will be directly aligned with the second inductive loop 61 of the light source 31. The second inductive loop 61 provides power for recharging the rechargeable power source 37 and receives power from the first inductive loop 57. This system of charging is similar to the systems employed by electric toothbrush manufacturers.

To remove the light source 31 from the corded telephone 11, the user need only manually pull on the light source 31, perhaps while holding the base 14 of the corded telephone 11.

Of course, other types of connections between the light source 31 and the corded telephone 11 are within the purview of the present invention. For example, a gravity connection could be employed whereby the light source 31 rests by gravity in a cradle or vertical slot formed in the base of the corded telephone 11.

Next, an operation of the device of FIG. 5 will be described. In typical operation, the corded telephone 11 has an RJ-type plug 51 connected to a wall jack and a power adapter 53 connected to a wall outlet. The power provided by the power adapter 53 powers the corded telephone 11 (e.g., speaker phone functions, display functions) and is also provided to the first and second electrical pads 27 and 29 so as to trickle charge the rechargeable power supply 37. In the case of the embodiment of FIGS. 3 and 4, power is provided to the first inductive loop 57 which passes power to the facing second inductive loop 61 to trickle charge the rechargeable power supply 37.

The user swivels the first and second light emitting elements 33 and 35 so as to direct them to areas of the room which would benefit from illumination in the event of a power failure. To this end, the user might slide the switch 41 to the “on” position. In the “on” position, light emitting diodes (LED)s within the first and second light emitting elements 33 and 35 are activated. The user would then turn off the overhead office lights in the room and adjust the positions of the first and second light emitting element 33 and 35. After, the adjustment of the positioning of the first and second light emitting elements 33 and 35, the switch 41 is placed in the “auto” position.

In normal operation, the corded telephone 11 monitors the power output by the power adapter 53. A loss of power output is taken to be indicative of a loss of power at the outlet, which in turn is taken to be indicative of a loss of power to the overhead lights. When a power loss is sensed, the corded telephone 11 either sends an “activation” signal to the light source 31 via the first and second electrical pads 27 and 29 (or the first inductive loop 57), or removes trickle charge power being sent to the light source 31 via the first and second electrical pads 27 and 29 (or the first inductive loop 57). In either instance, the first and second light emitting elements 33 and 35 are turned on to provide illumination L.

The illumination will provide an emergency light so that the occupant of the office can see obstructions and safely be able to reach the door of the room. Alternatively, the occupant of the room may wish to remove the light source 31 from the corded telephone 11. The light source 31 can then be used to as a portable flashlight to assist the occupant in gathering important items (e.g., a coat, a purse) and in evacuating the building.

Of course, the light source 31 could be useful in non-emergency situations. For example, a user could remove the light source 31 from the corded telephone 11 and, via the switch 41, use the light source 31 as any typical flashlight.

When the switch 41 is in the “off” position, the light source 31 will not emit light when removed from the corded telephone 11, or even when attached to the corded telephone 11 during a power failure situation. When the switch 41 is “auto” position, the light source 31 will not emit light when attached to the telephone and no power failure condition exists, the light source will emit light when attached to the corded telephone 11 and a power failure condition exists, and the light source 31 will emit light when the light source 31 is removed from the corded telephone 11. When the switch 41 is in the “on” position, the light source 31 is will emit light when detached from the corded telephone 11 and when attached to the corded telephone 11, regardless of any power failure.

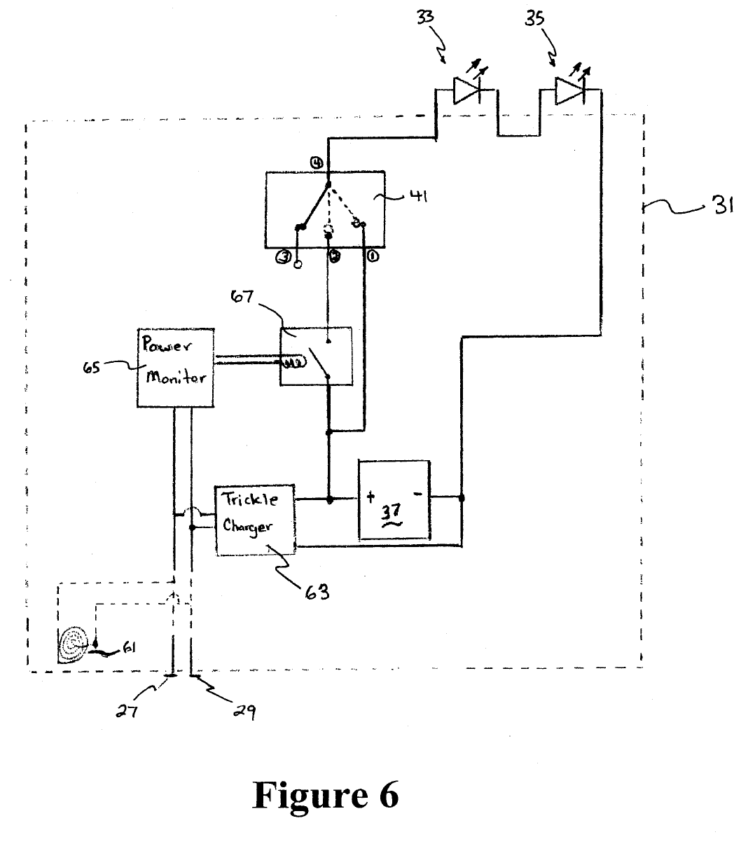

FIG. 6 is a schematic illustration of one circuit which can accomplish the operation described above. Of course, other types of circuits or microprocessor based systems could also accomplish the same results. In FIG. 6, the second coupling features of the light source 31, in other words the third and fourth electrical pads 38 and 39 (FIG. 2) or the second inductive loop 61 (FIG. 4), receive power from the first coupling features of the corded telephone 11.

Received power is provided to a trickle charger 63 and to a power monitor 65. The trickle charger 63 maintains a charge on the rechargeable power supply 37. The power monitor 65 monitors whether or not power is being received. So long as power is being received, a normally closed relay 67 is power to remain in its open state.

The positive terminal of the rechargeable power supply 37 is connector to an input of the relay 67 and also connected to a number (1) input terminal of the switch 41. The output of the relay 67 is connected to a number (2) input terminal of the switch 41. The number (3) input terminal of the switch 41 is disconnected. The switch 41 is a three-way switch, which can connect one of the number (1), (2) or (3) input terminals to a number (4) output terminal. When the switch connects the number (1) input terminal to the number (4) output terminal, the switch is in the “ON” position. When the switch connects the number (2) input terminal to the number (4) output terminal, the switch is in the “AUTO” position. When the switch connects the number (3) input terminal to the number (4) output terminal (as illustrated), the switch is in the “OFF” position.

The number (4) output terminal of the switch 41 is connected to a first LED, constituting the first light emitting element 33. The first LED is connected to a second LED, constituting the second light emitting element 35. The second LED is connected to the negative terminal of the rechargeable power supply 37. Six volt LEDs are currently preferred. By the illustrated connections, the switch 41 will function as described above.

In an enhanced embodiment, a timer may be disposed between the output of the relay 67 and the number (2) input terminal of the switch 41. The timer would draw power from the rechargeable power source 37. After an elapsed period of time (e.g., 1 minute or 10 minutes), the timer would electrically disconnect the output of the relay 67 from the number (2) input terminal of the switch 41. By this arrangement, when the switch 41 is in the “AUTO” position, the LEDs would initially be illuminated when a power outage occurred, but would be turned off after the period of time (e.g., two or three minutes). This would be a battery power saving feature which would prevent complete discharge of the batteries in the event that no person interacted with the corded telephone 11 during the power outage. If a person were present during the power outage, the person would have the period of time to leave the room with the assistance of the illumination, or the person could change the position of the switch 41 to “ON” so that the illumination would continue until the power source 37 was depleted or the user moved the switch 41 to the “OFF” position.

The battery saving feature could also be accomplished by replacing the timer with a light sensing cell disposed between relay 67 and the number (2) input terminal of the switch 41. If a power outage occurred and the light sensing cell determined that a light level in the room already exceeded a predetermined level, then the light sensing cell would act to disconnect the output of the relay 67 from the number (2) input terminal of switch 41. In other words, the LEDs would not be automatically lit during a power outage, when the light level in the room is already sufficient to see. Of course, the user could always set the switch 41 to the “ON” position and cause the LEDs to light up, if desired.

Of course, several of the benefits of the present invention could be accomplished even if the light source 31 were not removable from the corded telephone. Emergency illumination within the room would still be available even if the light source were fixed to the corded telephone 11. However, the user could not take the light source 31 with them and use it as a portable flashlight.

FIG. 5A illustrates an embodiment wherein the first and second light emitting elements 33 and 35 have been incorporated into the housing 15 of the corded telephone 11′, either in a fixed configuration or to permit user selected orientations via a swivel mount. There would be no need for the first and second coupling elements or even for the housing 32 of the light source. Further, the switch 41 could be replaced by function key 18A, 18B and 18C for representing the “OFF,” “AUTO” and “ON” user selections, respectively. Further, the rechargeable power supply 37 could be incorporated into the corded telephone's housing 15 or power for the light emitting elements 33 and 35 could be provided by a network connection to the telephone (e.g., via a power-over Ethernet source).

The benefits of the present invention are also applicable to portable telephones, such as a cordless type telephone which communicates via a local user's personal base station or a wireless type telephone which communicates via a service provider's cellular tower.

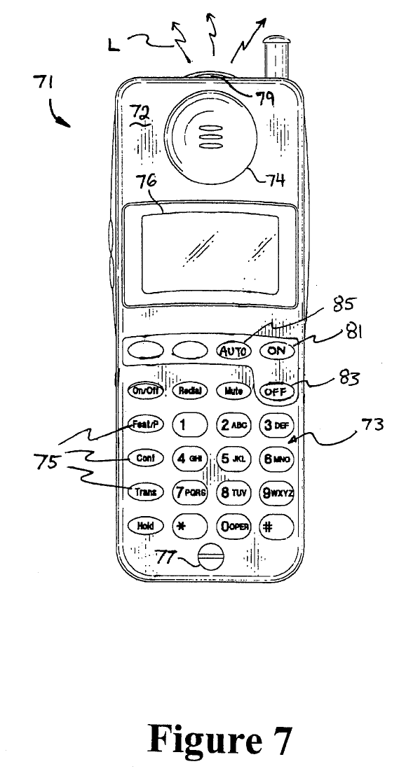

FIG. 7 illustrate a cordless telephone 71, in accordance with the present invention. The cordless telephone 71 includes typical telephone structures, such as a housing 72 presenting a numerical keypad 73, a speaker 74, a plurality of function keys 75, a display 76, and a microphone 77.

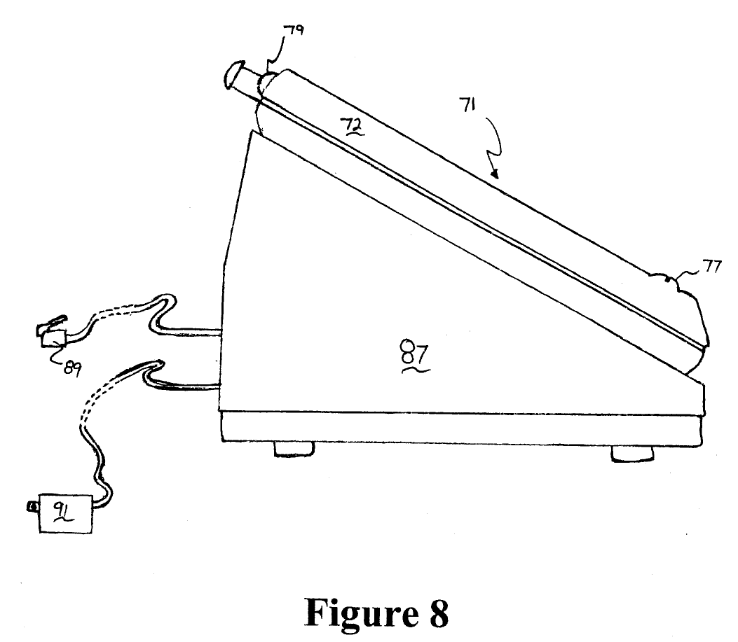

The cordless telephone 71 also includes structural feature related to the present invention, including a light emitting element 79, and light function keys 81, 83 and 85 relating to the functions of “ON,” “OFF” and “AUTO,” respectively. As illustrated in FIG. 8, the cordless telephone is designed to rest in a face up position on a base station 87. The base station 87 is hardwired to an RJ-type plug 89 and a power adapter 91.

Now the operation of the lighting system of the cordless telephone 71 will be described. In normal operation, the cordless telephone 71 monitors the air waves for a signal from the base station 87. A loss of signal from the base station is taken to be indicative of a loss of power at the outlet powering the adapter 91 of the base station, which in turn is taken to be indicative of a loss of power to the overhead lights. When a power loss is sensed, the cordless telephone 71 actives the light emitting element 79 to provide illumination L.

The illumination will provide an emergency light so that the occupant of the office can see obstructions and safely be able to reach the door of the room. The occupant of the room may wish to carry the cordless telephone 71 with them when exiting the building, as the cordless telephone could be used as a portable flashlight to assist the occupant in gathering important items (e.g., a coat, a purse) and in evacuating the building. A particular advantage of the embodiment of FIG. 7 and 8 is that a portable telephone, such as a cordless telephone 71 or a cellular telephone, already has a high capacity internal battery which can be used to power the light emitting element 79.

A loss of communication signal is usually not indicative of a power failure in the vicinity of a cellular telephone. Therefore, the automatic illumination operation in the event of signal loss is not employed for cellular telephones. However, such cellular telephones could still beneficially include a light source and a switch, with at least an “on” and “off” function, to allow the user to selectively use the cellular telephone's internal battery to power a light emitting element to assist the user in much the same way as a portable flashlight.

In the embodiments of FIGS. 1-6 the corded telephone 11 was receiving power via a power adapter 53. Hence, a power failure in the room where the corded telephone 11 was located could be predicted with relative accuracy by sensing the powered versus unpowered state of the power adapter 53. In some network systems, corded telephones 11′ receive power over the network (e.g., power-over-Ethernet systems). In such systems, the corded telephone 11′ does not require a power adapter 53 to be plugged into a wall outlet in the room where the corded telephone 11′ is located.

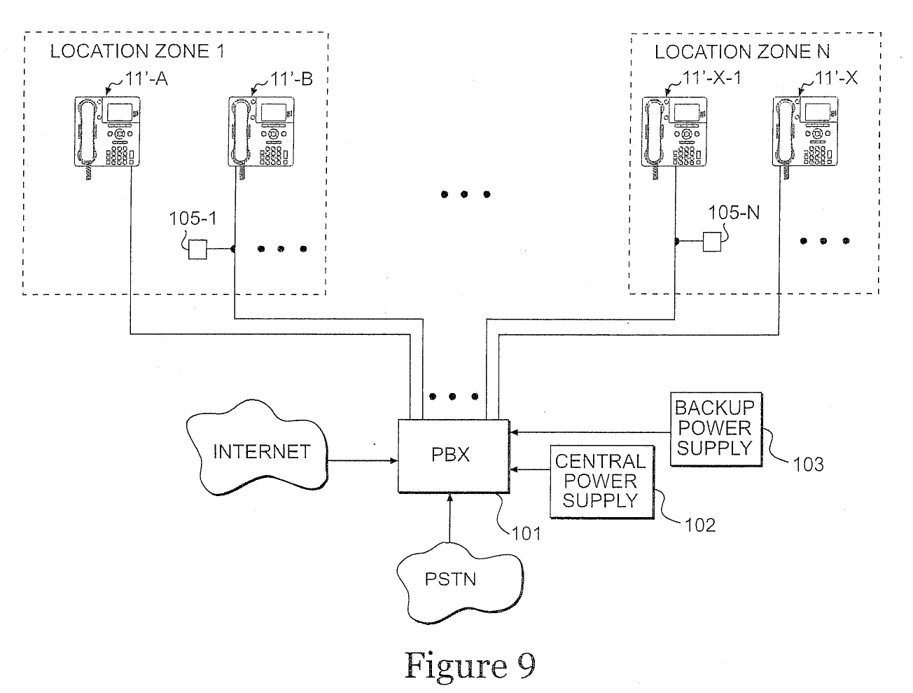

FIG. 9 illustrates a power-over-Ethernet system, in accordance with the present invention. In FIG. 9, a PBX unit 101 is connected to at least one of the Internet and the public switched telephone network (PSTN). The PBX unit is also connected to many telephones 11′-A, . . . , 11′-X throughout a network. The PBX unit 101 is typically connected to a central power supply 102 and a backup power supply 103 (e.g., a battery backup) so that telephone service will not be interrupted even during a power failure. As the telephones 11′ receive power from the PBX unit 101, the telephones 11′ would have no particular way of determining if a power outage occurs.

To further compound the issue a PBX unit 101 may provide service to telephones 11′ on several floors of a building or to several buildings around a campus. A power failure on one floor of a building or in one building is not indicative of a power failure on all floors of a building and in all building on a campus. Therefore, the PBX unit 101 must group telephones 11′ into location zones serviced by a common power source or sub-circuit (e.g. a common 200 AMP breaker). The telephones 11′ on the network each have a unique identification code and that code is usually collated with a physical location of the telephone 11′ (e.g., building 2, room 6C32). Based upon this information telephone identification codes can be grouped into location zones 1 to N, which are serviced by common electrical sub-circuits.

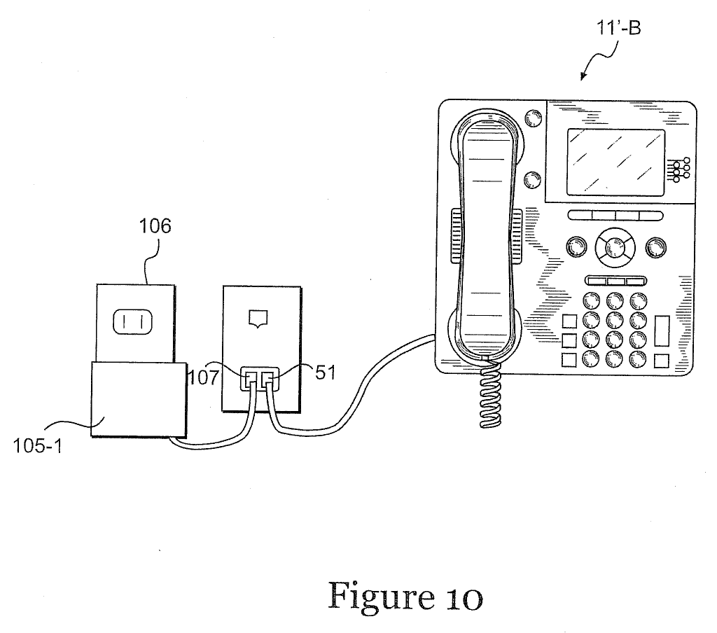

Within each location zone 1 to N, a power monitoring module 105-1 to 105-N may be installed. As illustrated in FIG. 10, the module 105-1 is plugged into a wall outlet 106 being powered by the sub-circuit servicing the location zone 1. The module 105-1 has a unique identification code which is collated to the location zone 1 and stored in the memory of the PBX unit 101. The module 105-1 is also connected to the network via a standard RJ-type plug 107.

The module 105-1 includes an internal power source (such as a battery or capacitor) and monitors the power provided at the outlet 106, such as by sampling the voltage level. Whenever a power outage occurs, the module 105-1 senses the same and transmits a signal to the PBX unit 101 reporting the power outage and the module's unique identification code. The PBX unit 101 may be programmed to disregard a power outage condition at a certain location and/or at certain times, as the power outage may be intentional and planned, such as to conserve energy or for scheduled maintenance or repair work. If the power outage is unplanned, the PBX unit 101 accesses its stored data and determines the location zone N for the power outage. Next, the PBX unit 101 accesses its memory and locates the identification codes for the telephones 11′ located within that location zone N. Finally, the PBX unit 101 transmits a signal over the network which causes illumination of the light emitting elements 33 and 35 of the telephones 11′ within the location zone N having the power outage.

Of course, it is envisioned that the end users of the telephone 11′ would still have switched control of the light emitting elements 33 and 35, such that only telephones 11′ with the switch 41 in the “AUTO” position would respond to the signal to the PBX unit 100 and provide illumination. Further, it is envisioned that the telephones 11′ could have removable light sources 31, rechargeable power supplies 37, and all of the other various alternative structural designs as mention in the detail description above.

Although the figures have illustrated LED type light emitting devices, the light source 31 could be constructed using any known type of light emitting device, such as an incandescent source, a fluorescent source, a halogen source, and combinations of different light sources. In a preferred embodiment for each type of telephone, the chosen light emitting device, or devices (collectively), provide at least four foot-candles, or four lumens per square foot. However, for better illumination of a room at least ten or even twenty foot-candles could be provided.

Although the figures have illustrated a battery as the rechargeable power supply 37, any other type of power supply may be employed, such as a capacitor. Although the figures have illustrated a switch 41 or function keys 18A, 18B, 18C as controls for the light source, other types of controls may be used, such as a touch screen or voice recognition commands.

Although the illumination in response to a power outage has been described as being a constantly on illumination, the light emitting elements could be made to flash in the event of the power outage. Such a feature could be an additional option to be made by a user selection via a switch, button or menu of the telephone. In residential applications, such a flashing feature could be advantageous to wake a sleeping person and alert them that to a power outage has occurred, which would allow them to quickly call for service and take steps to avoid loss of refrigerated foods, flood damage when sump pumps are in operation, etc. Moreover, the flashing light feature could also be accompanied by a buzzer sound to better wake the person. Moreover, the flashing light feature could be used to warn of emergency situations, such as a fire, gas leak, intruder, etc. Such emergencies could be reported to the PBX by a security system, which would in turn send a signal to all telephones connected thereto, or only telephones in a certain area, to flash the light emitting elements as an alarm feature.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A telephone comprising:
a housing; and
a light source removably attached to said housing, wherein said light source includes at least one light emitting element and a rechargeable power source selectively powering said at least one light emitting element, wherein said rechargeable power source is recharged when said light source is attached to said housing.

2. The telephone according to claim 1, wherein said housing is a base, and further comprising:
a handset; and
a cord connecting said handset to said base.

3. The telephone according to claim 2, wherein said at least one light emitting element can be manually reoriented relative to said base to illuminate a particular area of a room while said light source is attached to said base.

4. The telephone according to claim 2, wherein said at least one light emitting element includes first and second light emitting elements, and wherein at least one said first and second light emitting elements can be manually directed to illuminate a particular area of a room while said light source is attached to said housing.

5. The telephone according to claim 2, comprising:
a magnet attached to at least one of said base and said light source, said magnet serving to secure an removable attachment between said light source and said base.

6. The telephone according to claim 1, wherein said at least one light emitting element includes at least one light emitting diode (LED).

7. The telephone according to claim 1, wherein said at least one light emitting element is automatically illuminated when said light source is detached from said housing.

8. The telephone according to claim 1, wherein said at least one light emitting element is automatically illuminated when power to said telephone is interrupted.

9. The telephone according to claim 1, wherein said at least one light emitting element is automatically illuminated when said telephone supplies a particular signal or fails to supply a particular signal to said light source.

10. A telephone comprising:
a rechargeable power source;
a light source electrically connected to said rechargeable power source; and
a manually operable switch interposed within an electrical connection between said rechargeable power source and said light source, wherein a user may selectively cause at least one light emitting element of said light source to emit illumination and to stop emitting light by manipulation of said switch.

11. The telephone according to claim 10, wherein said rechargeable power source, light source and manually operable switch are housed within common housing of a wireless handset and further comprising:
a base station; and
a cradle within said base station to receive said wireless handset.

12. The telephone according to claim 11, wherein said light source outputs an illumination level of at least 4 foot-candles.

13. The telephone according to claim 11, wherein said at least one light emitting element can be manually reoriented relative to said common housing of a wireless handset to illuminate a particular area of a room while said wireless handset resides within said cradle of said base.

14. The telephone according to claim 11, wherein said at least one light emitting element is automatically illuminated when power to said base is interrupted.

15. The telephone according to claim 11, wherein said at least one light emitting element is automatically illuminated when said base supplies a particular signal or fails to supply a particular signal to said wireless handset.

16. The telephone according to claim 10, wherein said rechargeable power source, light 'source and manually operable switch are housed within common housing of a base and further comprising:
a handset; and
a cord connecting said handset to said base.

17. A telephone comprising:
a housing; and
a light source attached to said housing, wherein said light source includes at least one light emitting element and a rechargeable power source selectively powering said at least one light emitting element, wherein said at least one light emitting element may be manually reoriented relative to said housing by a user to provide illumination of a desired area.

18. The telephone according to claim 17, wherein said housing is a base, and further comprising:
a handset; and
a cord connecting said handset to said base.

19. The telephone according to claim 17, wherein said at least one light emitting element includes at least one light emitting diode (LED).

20. The telephone according to claim 17, wherein said light source is removably attached to said housing, and wherein said at least one light emitting element is automatically illuminated when said light source is detached from said housing.

21. The telephone according to claim 17, wherein said at least one light emitting element is automatically illuminated when power to said telephone is interrupted.

22. The telephone according to claim 17, wherein said at least one light emitting element is automatically illuminated when said telephone supplies a particular signal or fails to supply a particular signal to said light source.

23. A telephone comprising:
a housing; and
a light source attached to said housing, wherein said light source includes at least one light emitting element and a rechargeable power source selectively powering said at least one light emitting element, wherein said at least one light emitting element is automatically illuminated when said telephone supplies a particular signal or fails to supply a particular signal to said light source.

24. The telephone according to claim 23, wherein said housing is a base, and further comprising:
a handset; and
a cord connecting said handset to said base.

25. The telephone according to claim 23, wherein said at least one light emitting element includes at least one light emitting diode (LED).

26. The telephone according to claim 23, wherein said at least one light emitting element is automatically illuminated when power to said telephone is interrupted.

27. A telephone comprising:
a housing;
a light source removably attached to said housing, wherein said light source includes at least one light emitting element and a rechargeable power source electrically connected to said at least one light emitting element; and
a manually operable switch interposed within an electrical connection between said rechargeable power source and said light source,
wherein a user may selectively cause at least one light emitting element of said light source to emit illumination and to stop emitting light by manipulation of said switch,
wherein said rechargeable power source is recharged when said light source is attached to said housing,
wherein while said light source is attached to said housing said at least one light emitting element may be manually reoriented relative to said housing by a user to provide illumination of a desired area; and
wherein said at least one light emitting element is automatically illuminated when said telephone supplies a particular signal or fails to supply a particular signal to said light source.

28. A telephone comprising:
a housing; and
a light source attached to said housing, wherein said light source includes at least one light emitting element capable of receiving power for illumination from a remote server, wherein said at least one light emitting element is automatically illuminated when said telephone or remote server supplies a particular signal or fails to supply a particular signal to said light source indicative of a power failure.

29. A method of operating a light source provided on a telephone comprising:
recharging a battery for powering the light source;
sensing a condition, wherein the condition is the presence or absence of a particular signal received by the telephone; and
activating the light source to provide illumination in response to the sensed condition.

30. The method of claim 29, wherein the particular signal is generated by a remote device in communication with the telephone, and wherein the presence or absence of the particular signal indicates an unintended loss of power in a building in the vicinity of the telephone.

31. The method of claim 30, wherein the remote device is a base station capable of wireless communication with the telephone.

32. The method of claim 30, wherein the remote device is server in wired communication with the telephone.

33. The method of claim 29, wherein the particular signal indicates whether or not power is being received by the telephone.
